(19) United States
(12) Patent Application Publication
(10) Pub. No.: US 2009/0136241 A1
(43) Pub. Date: May 28, 2009

(54) OPTICAL MSK DATA FORMAT

(75) Inventors: Jinyu Mo, Singapore (SG); Yi Dong, Singapore (SG)

Correspondence Address: MCDERMOTT WILL & EMERY LLP, 18191 VON KARMAN AVE., SUITE 500, IRVINE, CA, 92612-7108, US

(73) Assignee: AGENCY FOR SCIENCE, TECHNOLOGY AND RESEARCH, SINGAPORE (SG)

(21) Appl. No.: 11/815,853

(22) PCT Filed: Feb. 8, 2006
(86) PCT No.: PCT/SG2006/000023

§ 371 Date: Nov. 12, 2008

Related U.S. Application Data
(60) Provisional application No. 60/650,816, filed on Feb. 8, 2005.

(51) Int. Cl. H04B 10/04

(52) U.S. Cl. 398/188

(57) ABSTRACT

A method of generating an optical minimum shift keying (MSK) modulated signal, a method of pre-coding an input data stream for generation of an optical MSK modulated signal, a method of decoding an optical MSK modulated signal, an MSK transmitter, an encoder structure for encoding an input data stream for generation of an optical MSK modulated signal, and a receiver structure for decoding an optical MSK modulated signal. The method of generating an optical minimum shift keying (MSK) modulated signal comprises amplitude modulating a first optical signal utilising a clock signal having a clock frequency to generate a carrier suppressed return-to-zero (CS-RZ) second optical signal; splitting the second optical signal into a third and a fourth optical signals in a first arm and a second arm respectively; applying a substantially 1-bit time delay in the first arm and applying a phase shift in the second arm such that a phase difference between the first and second arms is π/2; applying phase modulation in the first and second arms according to respective bit sequences; and combining the third and fourth signals from the first and second arms into the optical MSK modulated signal.

### FIELD OF INVENTION

The present invention related broadly to a method of generating an optical minimum shift keying (MSK) modulated signal, to a method of pre-coding an input data stream for generation of an optical MSK modulated signal, to a method of decoding an optical MSK modulated signal, to an MSK transmitter, to an encoder structure for encoding an input data stream for generation of an optical MSK modulated signal, and to a receiver structure for decoding an optical MSK modulated signal.

### BACKGROUND

The increasing capacity requirement for optical communication networks has generated a need to develop modulation formats to provide better immunity to impairments such as those arising from amplified spontaneous noise, dispersion and fiber nonlinear effects, as well as to allow higher channel density or spectral efficiency. Much work has been carried out on on-off-keying (OOK) formats, differential phase shift keying (DPSK), return-to-zero (RZ)-DPSK, differential quadrature PSK (DQPSK), and continuous-phase frequency shift keying (CPFSK). In particular, RZ-DPSK has shown promising performance in transmission due to a 3 dB reduction in optical signal to noise ratio (OSNR) requirement and more robustness to cross-phase modulation (XPM).

However, in particular for high speed and high spectral efficiency wavelength division multiplexing (WDM) systems, the limited dispersion tolerance, as well as the limited robustness against an inter-symbol-interference (ISI) effect arising from tight optical filtering, still remain as disadvantages of RZ-DPSK as a modulation format.

A need therefore exists to provide a modulation format and technique which seek to address at least one of the above mentioned disadvantages.

### SUMMARY

In accordance with a first aspect of the present invention there is provided a method of generating an optical minimum shift keying (MSK) modulated signal, the method comprising amplitude modulating a first optical signal utilising a clock signal having a clock frequency to generate a carrier suppressed return-to-zero (CS-RZ) second optical signal; splitting the second optical signal into a third and a fourth optical signals in a first and a second arms respectively; applying a substantially 1-bit time delay in the first arm and applying a phase shift in the second arm such that a phase difference between the first and second arms is π/2; applying phase modulation in the first and second arms according to respective bit sequences; and combining the third and fourth signals from the first and second arms into the optical MSK modulated signal.

The second optical signal may have a modulation frequency of substantially twice the clock frequency.

The second optical signal may be approximated as a substantially dual mode optical field.

The respective bit sequences may comprise pre-coded bit sequences generated from an input data stream, and the method further comprises pre-coding the input data stream utilising an exclusive-OR (EXOR) gate, separating the pre-coded data stream into an even bits sequence and an odd bits sequence, applying a substantially 1-bit delay to the even bits sequence, and applying the phase modulation in the first and second arms according to the even bits and odd bits sequences respectively.

In accordance with a second aspect of the present invention there is provided a method of pre-coding an input data stream for generation of an optical MSK modulated signal, the method comprising coding the input data stream utilising an exclusive-OR (EXOR) gate; separating the coded data stream into an even bits sequence and an odd bits sequence; and applying a substantially 1-bit delay to the even bits sequence.

In accordance with a third aspect of the present invention there is provided a method of decoding an optical MSK modulated signal, the method comprising inputting the optical MSK modulated signal into a substantially 1-bit delay interferometer (DI); and utilising a balanced receiver for detecting output signals at a first and a second output ports of the DI.

The DI may have a substantially π/2 phase shift between arms of the DI, and wherein the decoded optical signal is the output from the balanced receiver.

The DI may have a substantially zero phase shift between arms of the DI, and the method further comprises inputting an output from the balanced receiver into an EXOR gate, wherein the decoded optical signal is the output from the EXOR gate.

In accordance with a fourth aspect of the present invention there is provided an optical minimum shift keying (MSK) transmitter comprising an amplitude modulator for amplitude modulating a first optical signal to generate a carrier suppressed return-to-zero (CS-RZ) second optical signal; a splitter for splitting the second optical signal into a third and a fourth optical signals in a first and a second arms respectively; a delay element applying a substantially 1-bit time delay Δt in the first arm; a phase shift element for applying a phase shift in the second arm such that a phase difference between the first and second arms is π/2; a first and a second phase modulators for applying phase modulation in the first and second arms respectively according to respective bit sequences; and a combiner for combining the third and fourth signals from the first and second arms into the optical MSK modulated signal.

The second optical signal may have a modulation frequency of substantially twice the clock frequency.

The second optical signal may be approximated as a substantially dual mode optical field.

The respective bit sequences may comprise pre-coded bit sequences generated from an input data stream, and the structure further comprises an exclusive-OR (EXOR) gate for pre-coding the input data stream; a seperator for separating the pre-coded data stream into an even bits sequence and an odd bits sequence; a further delay element for applying a substantially 1-bit delay to the even bits sequence; and wherein the phase modulation in the first and second arms is applied according to the even bits and odd bits sequences respectively.

In accordance with a fifth aspect of the present invention there is provided an encoder structure for pre-coding an input data stream for generation of an optical MSK modulated signal, the structure comprising an exclusive-OR (EXOR) gate for coding the input data stream; a seperator for separating the coded data stream into an even bits sequence and an odd bits sequence; and a delay element for applying a substantially 1-bit delay to the even bits sequence.

The seperator may comprise a 1:2 electrical demultiplexer.

In accordance with a sixth aspect of the present invention there is provided a receiver structure for decoding an optical MSK modulated signal, the structure comprising a substantially 1-bit delay interferometer (DI) receiving the optical MSK modulated signal at an input port thereof; and a balanced receiver for detecting output signals at a first and a second output ports of the Di.

The DI may have a substantially π/2 phase shift between arms of the DI, and wherein the decoded optical signal is the output from the balanced receiver.

The DI may have a substantially zero phase shift between arms of the Di, and the structure further comprises an EXOR gate coupled to an output from the balanced receiver, wherein the decoded optical signal is the output from the EXOR gate.

### BRIEF DESCRIPTION OF THE DRAWINGS

Embodiments of the invention will be better understood and readily apparent to one of ordinary skill in the art from the following written description, by way of example only, and in conjunction with the drawings, in which:

FIG. 1(a) shows the configuration of a high-speed optical minimum shift keying (MSK) transmitter 100.

FIG. 1(b) shows an encoder structure.

FIG. 2 (a) shows a receiver configuration for optical MSK detection.

FIG. 2 (b) shows another receiver configuration for optical MSK detection.

FIG. 2 (c) shows details of the balanced receiver in the receiver configurations in FIGS. 2(a) and (b).

FIG. 3 shows the bit stream illustrations for the optical MSK generation and detection.

FIG. 4(a) shows the optical spectrum of the optical MSK signal and the spectrum of the RZ-DPSK signal.

FIGS. 4(b) and (c) show the spectra and eye patterns from the two output ports of a 1-bit delay interferometer respectively of a receiver for the optical MSK modulated signal (This is only valid for the receiver configuration as shown in FIG. 2 (a). Not true if the receiver configuration is using as shown in FIG. 2 (b).).

FIG. 5 shows the simulated eye opening penalty as a function of residual dispersion for comparison between the optical MSK, RZ-DPSK (50% duty cycle) and RZ-OOK (50% duty cycle) formats.

FIG. 6 shows the simulated eye opening penalty as a function of fiber launching power for comparison between the optical MSK, RZ-DPSK (50% duty cycle) and RZ-OOK (50% duty cycle) formats.

FIG. 7 (a) shows the chirp (frequency shift keying) due to the existence of the higher order side modes, when the conventional CSRZ pulse train is used for sinusoidal weighting in optical MSK.

FIG. 7 (b) shows the chirp (frequency shift keying) when an ideal dual mode optical signal is used for sinusoidal weighting in optical MSK.

FIGS. 8 (a)-(c) show the resultant eye patterns at a balanced receiver, 1-bit delay interferometer output port 1 and 1-bit delay interferometer output port 2 respectively of a receiver for the optical MSK modulated signal, when the conventional CSRZ pulse train is used for sinusoidal weighting in optical MSK.

FIG. 9 shows the power penalty as a function of spectral efficiency for optical MSK, for RZ-DPSK (50% duty cycle), and for RZ-OOK (50% duty cycle).

FIG. 10 shows a flowchart 1000 illustrating a method of generating an optical minimum shift keying (MSK) modulated signal according to the example embodiment.

FIG. 11 shows a flowchart 1100 illustrating a method of encoding an input data stream for generation of an optical MSK modulated signal according to the example embodiment.

FIG. 12 shows a flowchart 1200 illustrating a method of decoding an optical MSK modulated signal, according to the example embodiment.

### DETAILED DESCRIPTION

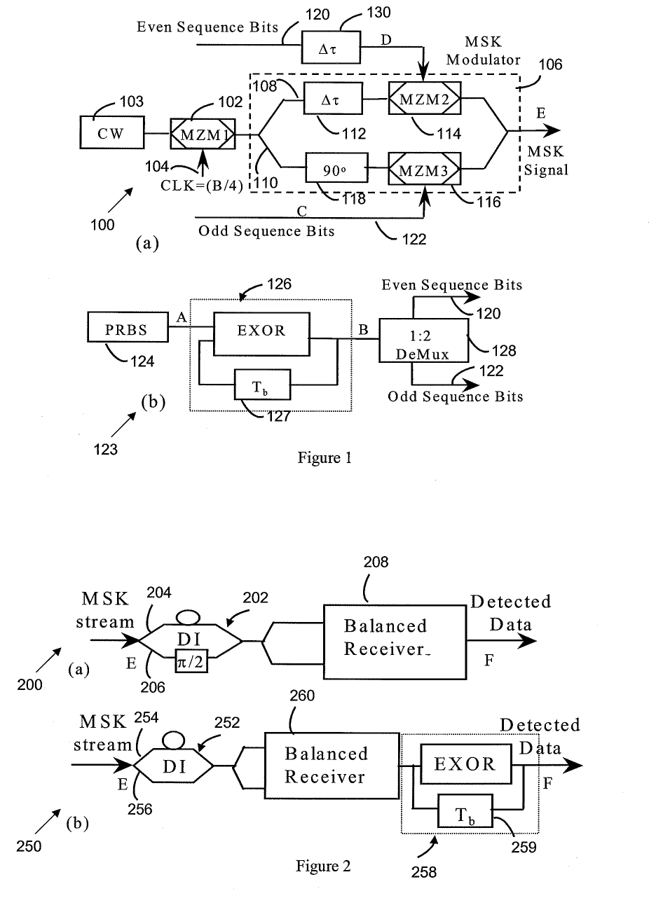

FIG. 1(a) shows the configuration of a high-speed optical minimum shift keying (MSK) transmitter 100 in the example embodiment. A first Mach-Zehnder modulator 102 (MZM1) is used for carrier suppressed return-to-zero (CS-RZ) pulse generation from a carrier signal from a continuous wave (CW) laser source 103 to generate the sinusoidal weighing for an offset quadrature phase shift keying (OQPSK) based implementation. The modulator 102 is driven by a clock signal 104 with a frequency of one quarter of the system bit rate B and is biased at the transmission null point. The CS-RZ pulses are then fed into the second modulator 106 (termed optical MSK modulator hereinafter), which consists of two arms 108, 110. A 3 dB 1-to-2 splitter or Y-junction may be used to split the CS-RZ pulses into arms 108, 110. One arm 108 has a 1-bit delay element 112 (Δτ=T_{b}=1/B, where T_{b} is the bit duration) and a MZM 114 (MZM2), while the other arm 110 has another MZM 116 (MZM3) and a phase shifter 118 such that the two arms 108, 110 have substantially a 90 degree phase difference. MZM2 114 and MZM3 116 are biased at the transmission null point and driven by two data streams 120 (even bits) and 122 (odd bits) respectively with a driving voltage of 2V_{π}. This driving condition provides either 0 or π phase shift in each arm 108, 110 according to the values of the bit streams. The even bits and odd bits data sequences 120, 122 are at a bit rate of B/2, and are generated from an encoder structure 123, shown in FIG. 1(b). The modulators 102, 114, and 116 are in the form of LiNbO₃ Mach-Zehnder modulators (LN MZMs) in the example embodiment. The modulators 114 and 116 may be provided in other forms, including e.g. as LiNbO₃ phase modulators which have a straight line structure (not Mach-Zehnder structure).

If an exact 1-bit-delay can not be achieved in the arm 108, e.g. due to fabrication and process accuracy limitations, this can be compensated by adjusting the phase change in the phase shifter 118 in arm 110 accordingly.

A data stream, in the configuration shown in FIG. 1(b) from a pseudo-random binary sequence (PRBS) source 124, is first pre-coded using an exclusive-OR (EXOR) gate 126, including a 1 bit duration feedback loop 127, and is then separated by a 1:2 electrical demultiplexer 128 (functioning as a serial to parallel converter) to form the even bits and odd bits sequences 120, 122 for driving MZM3 116 and MZM2 114 (see FIG. 1(a)) respectively. Before the even bits sequence 120 is used to modulate MZM2 114, it is delayed by a 1-bit duration (Δτ=T_{b}), in order to synchronize with the CS-RZ pulses in the arm 108, indicated at numeral 130 in FIG. 1(a).

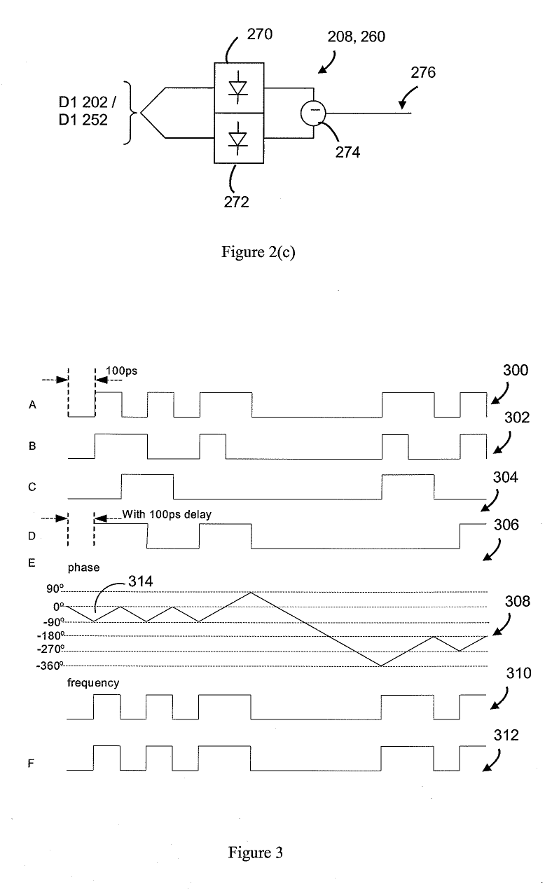

Two receiver configurations 200, 250 for optical MSK detection are shown in FIG. 2. As shown in FIG. 2 (a), the first receiver 200 consists of a 1-bit delay interferometer (DI) 202 with π/2 phase shift between two arms 204, 206, and a balanced receiver 208 In FIG. 2 (b), the receiver 250 includes a 1-bit DI 252 with 0 degree phase difference between two arms 254, 256 and an EXOR gate 258, with a 1 bit duration feedback loop 259, after balanced receiver 260. The two configuration 200, 252 are equivalent, in as much as the detected data has the same bit rate and a pattern corresponding to the original data, before the original data is differentially encoded as described above with reference to FIG. 1(b), as is described in more detail below.

As shown in FIG. 2(c), the balanced receivers 208, 260 consist of two PIN detectors 270, 272 coupled to respective output ports of the DI 202 or DI 252. The outputs from the PIN detectors 270, 272 are input into a substracter 274, for providing the detected output at numeral 276.

FIG. 3 shows the bit stream illustrations for the optical MSK generation and detection in the example embodiment, where “A” to “F” indicate data patterns at the corresponding locations as labelled in FIGS. 1 and 2. More particular, “A” illustrates an original data stream 300 intended for transmission, for T_{b}=1/B=100 ps. “B” illustrates the bit stream 302 of the data after the pre-coding after the EXOR gate 126 (see FIG. 1(b)), whereas “C” illustrates the demultiplexed odd bits sequence 304 after the 1:2 electrical demultiplexer 128 (see FIG. 1(b)). “D” illustrates the demultiplexed even bits sequence 306 with one bit delay after the 1:2 electrical demultiplexer 128 (see FIG. 1 (b)). “E” shows the phase 308 and frequency 310 of the transmitted optical MSK signal output from the MSK modulator 106 (see FIG. 1(a)). Finally, “F” illustrates the detected signal 312 at the receiver configurations 200, 250 (see FIG. 2), the detected signal 312 being identical to the original data stream 300.

Returning now to FIG. 1(a), the CS-RZ pulse train from the modulator MZM1 102 output can be approximated by a dual mode optical field

$$E ( t ) = \frac{1}{2} {E}_{in} \{ {e}^{j2π ( {f}_{0} + B / 4 ) t} + {e}^{j2π ( {f}_{0} - B / 4 ) t} \} = {E}_{in} {e}^{j2π {f}_{0} t} cos \frac{π B}{2} t \qquad ( 1 )$$

where f₀ is the optical carrier frequency, and Eᵢₙ is the optical field amplitude. Please note that an ideal dual mode pulse source can be obtained by using a bandpass filter to remove the higher order modes in the optical spectrum of the CS-RZ pulses.

Then the dual mode pulse train is input into the MSK modulator 106 and is separated into the two arms 108, 110. In the arm 108, the pulses are delayed one bit (Δt=1/B) and phase modulated by the even sequence bits (with bit rate B/2), which are demultiplexed from the original data stream and are also delayed one bit to synchronize the pulses, as described above. The optical filed of the arm 108 can be expressed as

$$\begin{matrix}{E}_{up} ( t ) = \frac{1}{\sqrt{2}} {E}_{in} {e}^{j2π {f}_{0} ( t - 1 / B )} cos [ \frac{π B}{2} ( t - \frac{1}{B} ) ] {e}^{j \frac{π}{{V}_{π}} {Data}_{even} ( t - 1 / B )} \\ = \frac{1}{\sqrt{2}} {E}_{in} {e}^{j2π {f}_{0} t} {e}^{- j2π {f}_{0} {T}_{b}} sin ( \frac{π B}{2} t ) {e}^{jπ {a}_{even} ( t - {T}_{b} )}\end{matrix} \qquad ( 2 )$$

where T_{b}=1/B is bit duration, and αᵤₚ=Dataₑᵥₑₙ/V_{π} is the bit value(s) and is 1 or 0 within the bit duration. The optical field of the arm 110 can be expressed as

$$\begin{matrix}{E}_{low} ( t ) = \frac{1}{\sqrt{2}} {E}_{in} {e}^{j2π {f}_{0} t} {e}^{jφ} cos ( \frac{π B}{2} t ) {e}^{j \frac{π}{{V}_{π}} {Data}_{odd} ( t )} \\ = \frac{1}{\sqrt{2}} {E}_{in} {e}^{j2π {f}_{0} t} {e}^{jφ} cos ( \frac{π B}{2} t ) {e}^{jπ {a}_{odd} ( t )}\end{matrix} \qquad ( 3 )$$

where φ is the tunable phase shift and δ is the residual phase. In Equ. (2), f₀ is much larger than B, so f₀/B>>1. However, one can express 2πf₀/B=2Nπ+δ, where N is a large integer and 0<δ<2π. If φ is adjusted to make δ−φ=π/2 such that the two arms 108, 110 have half π phase difference, as mentioned above, after combining the optical fields of the two arms 108, 110, the output of the MSK modulator 106 becomes

$${E}_{out} ( t ) = \frac{1}{2} {E}_{in} {e}^{j2π {f}_{0} t} {e}^{jπ / 2} sin ( \frac{π B}{2} t ) {e}^{jπ {a}_{even} ( t - {T}_{b} )} + \frac{1}{2} {E}_{in} {e}^{j2π {f}_{0} t} cos ( \frac{π B}{2} t ) {e}^{jπ {a}_{odd} ( t )} \qquad ( 4 )$$

where f₀ is the optical carrier frequency, Eᵢₙ is the optical field amplitude, and a_{odd} and aₑᵥₑₙ are the bit values, 1 or 0 within their bit durations, corresponding to the odd bits and even bits sequences 122, 120 respectively.

The real part of the optical field Eₒᵤₜ (t) gives

$${E}_{out , real} ( t ) = \frac{{E}_{in}}{2} sin ( 2 π {f}_{0} t ) sin ( \frac{π B}{2} t ) sin ( π {a}_{even} ( t - {T}_{b} ) + \frac{π}{2} ) + \frac{{E}_{in}}{2} cos ( 2 π {f}_{0} t ) cos ( \frac{π B}{2} t ) cos ( π {a}_{odd} ( t ) ) \qquad ( 5 )$$

which is the same as the mathematical expression of a MSK signal in digital communication.

Considering cos(πα_{odd} (t))=±1, Equ. (5) can also be expressed as

$$\begin{matrix}{E}_{out} ( t ) = \frac{{E}_{in}}{2} exp ( j {tan}^{- 1} [ tan ( \frac{π B}{2} t ) \times \frac{cos ( π {a}_{even} ( t - {T}_{b} ) )}{cos ( π {a}_{odd} ( t ) )} ] ) {e}^{j2π {f}_{0} t} \\ = \frac{{E}_{in}}{2} exp ( \pm j \frac{π B}{2} t ) {e}^{j2π {f}_{0} t}\end{matrix} \qquad ( 6 )$$

where the plus or minus sign corresponds to a_{odd}(t) and aₑᵥₑₙ(t−T_{b}) having the same or opposite bit values within the time interval kT_{b}≦t≦(k+1)T_{b}, respectively, where k is an integer.

Equ. (6) shows that the optical MSK signal has a constant amplitude, and its phase changes continuously and linearly within the time interval kT_{b}≦t≦(k+1)T_{b} with a slope variation at each bit transmission instant e.g. 314, as shown in curve 308 in FIG. 3 “E”. This slope variation corresponds to a frequency shift keying, and the bit pattern b(t) of the frequency modulation 310 has the same pattern as the original data 300 before differential encoding at point A in FIG. 1(b). Within kT_{b}≦t≦(k+1)T_{b}, b=1 or 0 correspond to a frequency shift of B/4 or −B/4, respectively, so Equ. (3) can be also expressed as Eₒᵤₜ (t)=Eᵢₙ exp(j[b(t)−0.5]πBt)e^{j2πƒ}^{₀}^{t}/2. In the MSK receiver 200, as shown in FIG. 2 (a), the output from the constructive port of the Di 202 can be expressed as

$${E}_{Dect} ( t ) = \frac{{E}_{in}}{4} \{ {e}^{j [ b ( t ) - 0.5 ] π Bt} + {e}^{j [ b ( t - {T}_{b} ) - 0.5 ] π B ( t - {T}_{b} ) + jφ - j 2 π {f}_{0} {T}_{b}} \} {e}^{j2π {f}_{0} t} \qquad ( 7 )$$

Express again 2πf₀/B=2Nπ+δ, where N is a large integer and 0<δ<2π. If 0 is adjusted to make δ−φ=π/2 such that the two arms 108, 110 have half π phase difference, as mentioned above, and dropping the high frequency optical carrier term, Equ. (7) becomes

$${E}_{Dect} ( t ) = \frac{{E}_{in}}{4} \{ {e}^{j [ b ( t ) - 0.5 ] π Bt} + {e}^{j [ b ( t - {T}_{b} ) - 0.5 ] π B ( t - {T}_{b} ) + jπ / 2} \} \qquad ( 8 )$$

By substituting “0” or “1” into b(t) and b(t−T_{b}), Equ. (8) shows that the demodulated bit stream 312 has the same pattern as the original data stream 300, as shown in FIG. 3.

The above theoretical derivation assumes the CS-RZ pulse train from the modulator MZM1 102 (FIG. 1(a)) is ideal dual mode, where higher order side modes are ignored. This reduces the duty cycle from 67% to 50%, and can be achieved by using an optical bandpass filter. Driving MZM1 102 with a drive swing less than 2V_{π} can also minimize the higher order side modes. However, it was found that the higher order side modes do not affect the generation of the optical MSK signal, and rather helped to achieve a better tolerance against fiber dispersion and nonlinear effects, as is described in more detail below.

With reference to FIG. 1(a), in an experimental set-up to demonstrate example embodiment, the first modulator 102 (MZM1) is driven by a 10.7/4 GHz clock signal 104 and outputs a 10.7/2 GHz CS-RZ pulse train. The 10.7 Gb/s MSK modulator 106 is fabricated using PLC-LN hybrid integration technology. A 10.7 Gb/s non-return to zero (NRZ) data from the PRBS source 124 with a word length of 2²³−1) is separated into the odd bits and even bits sequence bit streams 122, 120 with a bit rate of 10.7/2 Gb/s in each stream 122, 120. The modulators 114 MZM2 and 116 MZM3 are driven by a voltage of around 2V_{π}, which is about 9V. The output of the MSK modulator 106 is a 10.7 Gb/s optical MSK signal. No EXOR gate was used in the experimental set-up of the MSK transmitter and receiver (compare 125 in FIGS. 1(a) and 258 in FIG. 2(b)), since differential encoding PRBS generated by polynomial gives identical PRBS but with an offset.

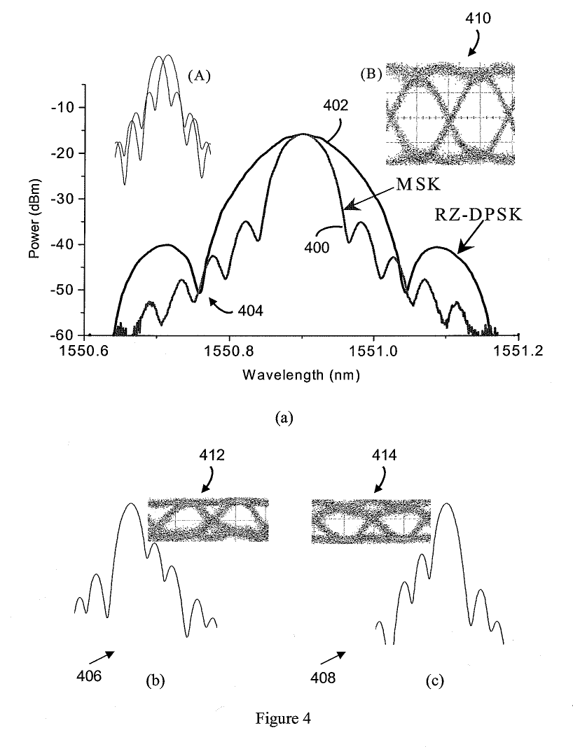

FIG. 4 shows the eye patterns and optical spectra of the generated optical MSK signal, and the optical spectrum for RZ-DPSK is also shown for comparison. As seen in FIG. 4(a), the optical spectrum 400 of the optical MSK signal is narrower than the spectrum 402 of the RZ-DPSK signal, and side-lobes e.g. 404 of the optical MSK spectrum are also lower. Hence, the optical MSK signal is expected to achieve higher spectral efficiency, larger dispersion tolerance and to reduce the crosstalk from the neighbouring channels and the ISI effect arising from tight optical filtering. FIGS. 4(b) and (c) show that the outputs from the two output ports of the DI 202 have similar optical spectra 406, 408, when the receiver configuration 200 in FIG. 2(a) is used. The outputs 406, 408 are the mirror images with respect to the central frequency. When these two spectra 406, 408 overlay each other, they form the spectrum 400 of the optical MSK signal (compare insert (A) in FIG. 4(a)). As will be appreciated by a person skilled in the art, the spectra 406, 408 are different from the corresponding spectra typically obtained for the RZ-DPSK signal. However, if the receiver configuration 250 in FIG. 2(b) is used, the demodulated optical MSK spectra will be similar to those of the RZ-DPSK spectra, with one constructive port and one destructive port. However, for both receiver configurations, the optical MSK exhibits narrower spectra and lower side lobes than the RZ-DPSK signal.

The inset (B) in FIG. 4(a) shows the eye pattern 410 detected by the balanced receiver (using the receiver configuration 200 as shown in FIG. 2(a)), and in FIGS. 4(b) and (c) show the eye patterns 412, 414 at the two output ports of the DI, corresponding to their optical spectra. Here the driving swing of MZM1 102 (FIG. 1(a)) for the CS-RZ pulse generation is less than 2V_{π}, leading to a reduced intensity in higher order side modes. The eye patterns 410, 412, 414 in FIG. 4 exhibit relatively flat borders at both the eye's top and bottom parts.

In the following, a detailed comparison of the characteristics between optical MSK and two other advanced modulation formats, RZ-DPSK (50% duty cycle) and RZ-OOK (50% duty cycle) formats is described, using a commercial software, VPItransmissionmaker. The tolerance against fiber dispersion and nonlinear effects was evaluated and compared, which are important aspects for comparison of advanced data formats. Large dispersion tolerance against potential changes in its residual dynamic dispersion is highly desirable to facilitate a cost effective link design and system installation, particularly at high line rates of 40 Gbit/s or beyond. Good nonlinearity tolerance allows signal transmitted over longer distance without introducing significant impairments.

To evaluate and compare the dispersion tolerances of the different data formats, signal transmission through the variation of either single span of single mode fiber (SMF) or dispersion compensation fiber (DCF) was simulated to generate the required dispersion levels. The fiber launch power was well controlled to make a power penalty caused by nonlinear effects negligible within such a short distance. In the simulation, for RZ-OOK, the received signals were directly detected by a receiver which consists of a PIN photo detector, while for optical MSK and RZ-DPSK, the received signals were detected using a balanced receiver which consisted of a one bit delay interferometer and two PIN photodiodes. The phase difference between the two arms of the delay interferometer was set at 90 degree for optical MSK and 0 degree for RZ-DPSK. The electrical filter bandwidth in the receiver module was set to 1 bit rate for all the three formats evaluated.

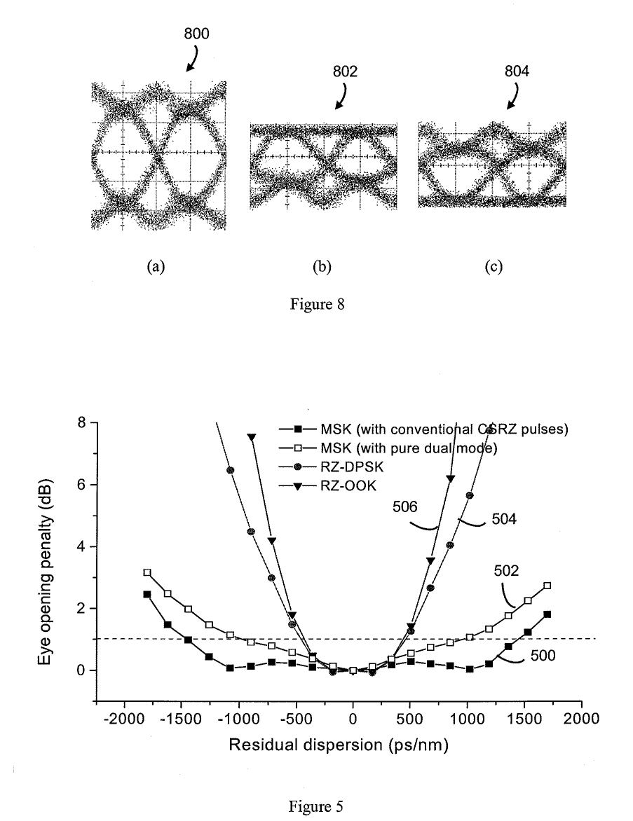

FIG. 5 shows the simulated eye opening penalty as a function of residual dispersion for comparison between the optical MSK, RZ-DPSK (50% duty cycle) and RZ-OOK (50% duty cycle) formats. For optical MSK generation, two techniques to achieve the sinusoidal weighing for OQPSK were considered. The first technique was using conventional CS-RZ pulses as shown in FIG. 1, while the second technique was using an additional optical bandpass filter following the MZM1 102 to remove the higher order side modes and obtain ideal dual mode pulses. As shown in FIG. 5, the optical MSK formats generated using both conventional CS-RZ pulses (curve 500) and ideal mode pulses (curve 502) exhibit larger 1 dB dispersion tolerance defined by eye opening penalty compared with RZ-DPSK (curve 504) and RZ-OOK, (curve 506), and optical MSK generated using conventional CS-RZ pulses (curve 500) has the widest dispersion tolerance among all these formats.

To evaluate the tolerance against fiber nonlinear effect, single channel transmission over an 8×80 km transmission link with different data formats was simulated, again for optical MSK, RZ-DPSK (50% duty cycle) and RZ-OOK (50% duty cycle). Each span consisted of 80 km SMF and corresponding DCF to make full dispersion compensation. Two stages erbium doped fiber amplifiers (EDFAs) were used to compensate for the total fiber loss in each span, and were placed before and after the DCF. In the simulation, the launch power into the DCF was fixed at −6 dBm, while the launch power into SMF was varied to change the accumulated self-phase-modulation (SPM). Amplified spontaneous emission (ASE) noise was deactivated in the simulation to focus on the effect of SPM. The receiver modules used in the simulations were the same as that for dispersion tolerance evaluation.

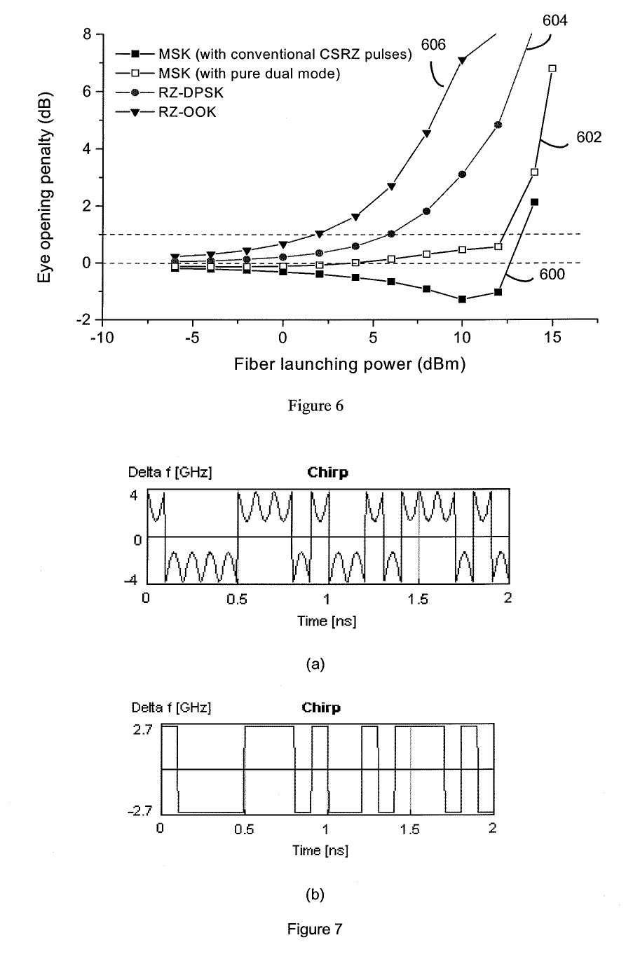

FIG. 6 shows the simulated eye opening penalty as a function of fiber launching power for comparison between the optical MSK, RZ-DPSK (50% duty cycle) and RZ-OOK (50% duty cycle) formats. FIG. 6 shows that the optical MSK formats generated using both conventional CS-RZ pulses (curve 600) and ideal mode pulses (curve 602) provide better tolerance against fiber nonlinear effects compared with RZ-DPSK (curve 604) and RZ-OOK (curve 606), and the optical MSK using conventional CS-RZ pulses (curve 600) exhibits the best nonlinear tolerance among all these formats. It was also noticed that when the fiber launching power was less than 12 dBm, the eye opening penalty of the optical MSK format generated using conventional CS-RZ pulses (curve 600) increases negatively with fiber launching power, while the eye opening penalty of the other formats increases positively. In order to understand this negative penalty, the chirp at the output of the optical MSK transmitter was investigated. It was found that there is an additional modulation on the chirp (frequency shift keying) due to the existence of the higher order side modes, as shown in FIG. 7 (a), when the conventional CSRZ pulse train generated by the modulator MZM1 (102, FIG. 1(a)) is used for sinusoidal weighting. FIGS. 8 (a)-(c) show the resultant eye patterns 800, 802, 804 at the balanced receiver, DI 202 output port 1 and DI 202 output port 2 (compare FIG. 2(a) respectively, which show more uneven borders at both the top and/or bottom of the eyes, compared with the eyes 410, 412, 414 in FIG. 4. If an ideal dual mode is used for sinusoidal weighting, this modulation on the chirp does not exist, as seen in FIG. 7(b), and the eye opening penalty of the optical MSK signal is positive (compare curve 602 in FIG. 6). It is believed that this negative penalty might be due to the modulation on the chirp.

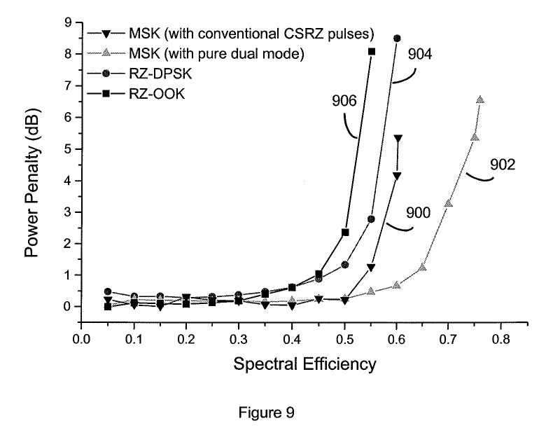

FIG. 9 shows a crosstalk comparison between the optical MSK, RZ-DPSK and RZ-OOK formats. More particularly, FIG. 9 shows the power penalty as a function of spectral efficiency for optical MSK with conventional CSRZ pulse train (curve 900), for optical MSK with ideal dual mode (curve 902), for RZ-DPSK (curve 904), and for RZ-OOK (curve 906). As will be appreciated, a lower power penalty with larger spectral efficiency is preferred, since this allows more channels to be packed into the limited spectral bandwidth, or the channel spacing can be made smaller. As can be seen from FIG. 9, the optical MSK formats generated using both conventional CS-RZ pulses (curve 900) and ideal mode pulses (curve 902) provide better crosstalk characteristics compared with RZ-DPSK (curve 904) and RZ-OOK (curve 906), and the optical MSK using ideal dual mode pulses (curve 902) exhibits the best crosstalk characteristics among all these formats.

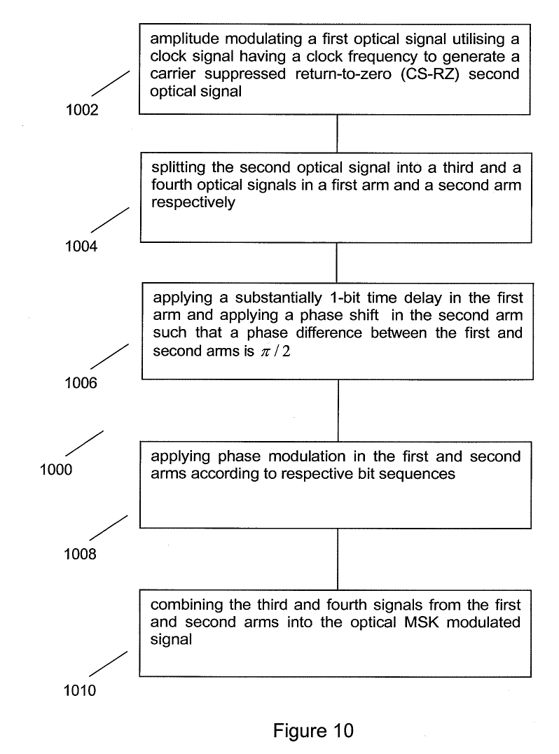

FIG. 10 shows a flowchart 1000 illustrating a method of generating an optical minimum shift keying (MSK) modulated signal according to the example embodiment. At step 1002, a first optical signal is amplitude modulated utilising a clock signal having a clock frequency to generate a carrier suppressed return-to-zero (CS-RZ) second optical signal. At step 1004, the second optical signal is split into a third and a fourth optical signals in a first arm and a second arm respectively. At step 1006, a substantially 1-bit time delay is applied in the first arm and a phase shift is applied in the second arm such that a phase difference between the first and second arms is π/2. At step 1008, phase modulation is applied in the first and second arms according to respective bit sequences. At step 1010, the third and fourth signals from the first and second arms are combined into the optical MSK modulated signal.

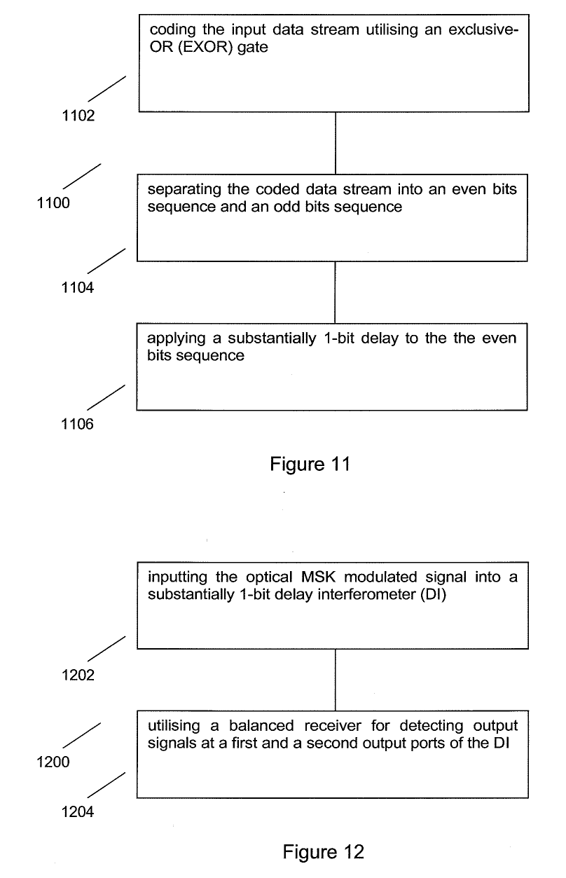

FIG. 11 shows a flowchart 1100 illustrating a method of encoding an input data stream for generation of an optical MSK modulated signal according to the example embodiment. At step 1102, the input data stream is pre-coded utilising an exclusive-OR (EXOR) gate. At step 1104, the pre-coded data stream is separated into an even bits sequence and an odd bits sequence. At step 1106, a substantially 1-bit delay is applied to the even bits sequence.

FIG. 12 shows a flowchart 1200 illustrating a method of decoding an optical MSK modulated signal, according to the example embodiment. At step 1202, the optical MSK modulated signal is input into a substantially 1-bit delay interferometer (DI). At step 1004, balanced receivers are utilised for detecting output signals at a first and a second output ports of the DI.

The optical MSK signal generation and detection in the example embodiments described exhibit a very compact optical spectrum, which is expected to achieve high spectral efficiency, large dispersion tolerance and low inter-channel crosstalk. Simulation results on dispersion and nonlinear tolerance comparison confirm that the optical MSK signal of the example embodiments has better dispersion and nonlinear tolerance defined by 1 dB eye opening penalty compared with RZ-DPSK and RZ-OOK formats. The optical MSK data generation scheme of the example embodiments is promising for high spectral efficiency WDM applications.

It will be appreciated by a person skilled in the art that numerous variations and/or modifications may be made to the present invention as shown in the specific embodiments without departing from the spirit or scope of the invention as broadly described. The present embodiments are, therefore, to be considered in all respects to be illustrative and not restrictive.

1. A method of generating an optical minimum shift keying (MSK) modulated signal, the method comprising:
amplitude modulating a first optical signal utilising a clock signal having a clock frequency to generate a carrier suppressed return-to-zero (CS-RZ) second optical signal;
splitting the second optical signal into a third and a fourth optical signals in a first arm and a second arm respectively;
applying a substantially 1-bit time delay in the first arm and applying a phase shift in the second arm such that a phase difference between the first and second arms is π/2;
applying phase modulation in the first and second arms according to respective bit sequences; and
combining the third and fourth signals from the first and second arms into the optical MSK modulated signal.

2. The method as claimed in claim 1, wherein the second optical signal has a modulation frequency of substantially twice the clock frequency.

3. The method as claimed in claims 1 or 2, wherein the second optical signal can be approximated as a substantially dual mode optical field.

4. The method as claimed in claim 3, wherein the respective bit sequences comprise pre-coded bit sequences generated from an input data stream, and the method further comprises pre-coding the input data stream utilising an exclusive-OR (EXOR) gate, separating the pre-coded data stream into an even bits sequence and an odd bits sequence, applying a substantially 1-bit delay to the even bits sequence, and applying the phase modulation in the first and second arms according to the even bits and odd bits sequences respectively.

5. A method of pre-coding an input data stream for generation of an optical MSK modulated signal, the method comprising:
coding the input data stream utilising an exclusive-OR (EXOR) gate;
separating the coded data stream into an even bits sequence and an odd bits sequence; and
applying a substantially 1-bit delay to the even bits sequence.

6. A method of decoding an optical MSK modulated signal, the method comprising:
inputting the optical MSK modulated signal into a substantially 1-bit delay interferometer (DI); and
utilising a balanced receiver for detecting output signals at a first and a second output ports of the DI.

7. The method as claimed in claim 6, wherein the DI has a substantially π/2 phase shift between arms of the Di, and wherein the decoded optical signal is the output from the balanced receiver.

8. The method as claimed in claim 6, wherein the DI has a substantially zero phase shift between arms of the DI, and the method further comprises inputting an output from the balanced receiver into an EXOR gate, wherein the decoded optical signal is the output from the EXOR gate.

9. An optical minimum shift keying (MSK) transmitter comprising:
an amplitude modulator for amplitude modulating a first optical signal utilising a clock signal having a clock frequency to generate a carrier suppressed return-to-zero (CS-RZ) second optical signal;
a splitter for splitting the second optical signal into a third and a fourth optical signals in a first arm and a second arm respectively;
a delay element applying a substantially 1-bit time delay Δt in the first arm;
a phase shift element for applying a phase shift in the second arm such that a phase difference between the first and second arms is π/2;
a first and a second phase modulators for applying phase modulation in the first and second arms respectively according to respective bit sequences; and
a combiner for combining the third and fourth signals from the first and second arms into the optical MSK modulated signal.

10. The transmitter as claimed in claim 9, wherein the second optical signal has a modulation frequency of substantially twice the clock frequency.

11. The transmitter as claimed in claims 9 or 10, wherein the second optical signal can be approximated as a substantially dual mode optical field.

12. The transmitter as claimed in any one of claims 9 to 11, wherein the respective bit sequences comprise pre-coded bit sequences generated from an input data stream, and the structure further comprises:
an exclusive-OR (EXOR) gate for pre-coding the input data stream;
a seperator for separating the pre-coded data stream into an even bits sequence and an odd bits sequence;
a further delay element for applying a substantially 1-bit delay to the even bits sequence; and
wherein the phase modulation in the first and second arms is applied according to the even bits and odd bits sequences respectively.

13. An encoder structure for pre-coding an input data stream for generation of an optical MSK modulated signal, the structure comprising:
an exclusive-OR (EXOR) gate for coding the input data stream;
a seperator for separating the coded data stream into an even bits sequence and an odd bits sequence; and
a delay element for applying a substantially 1-bit delay to the even bits sequence.

14. The encoder as claimed in claim 14, wherein the seperator comprises a 1:2 electrical demultiplexer.

15. A receiver structure for decoding an optical MSK modulated signal, the structure comprising:
a substantially 1-bit delay interferometer (DI) receiving the optical MSK modulated signal at an input port thereof; and
a balanced receiver for detecting output signals at a first and a second output ports of the DI.

16. The structure as claimed in claim 15, wherein the DI has a substantially π/2 phase shift between arms of the DI, and wherein the decoded optical signal is the output from the balanced receiver.

17. The structure as claimed in claim 15, wherein the DI has a substantially zero phase shift between arms of the DI, and the structure further comprises an EXOR gate coupled to an output from the balanced receiver, wherein the decoded optical signal is the output from the EXOR gate.
